(19) United States
(12) Patent Application Publication
(10) Pub. No.: US 2015/0203364 A1
(43) Pub. Date: Jul. 23, 2015

(54) INTEGRAL MEDIA RECONDITIONING AND RECOVERY SYSTEM

(71) Applicant: BLUE WATER TECHNOLOGIES, INC., Hayden, ID (US)

(72) Inventors: Cornelius J. Strain, Post Falls, ID (US); Eric Skidmore, Harrison, ID (US); Mark S. Lopp, Coeur d'Alene, ID (US)

(21) Appl. No.: 14/413,663

(22) PCT Filed: Jul. 18, 2013
(86) PCT No.: PCT/US2013/051040

§ 371 Date: Jan. 8, 2015

Related U.S. Application Data
(60) Provisional application No. 61/673,181, filed on Jul. 18, 2012.

(51) Int. Cl. C02F 1/28; B01D 15/20

(52) U.S. Cl. CPC C02F 1/28; B01D 15/20; C02F 2303/16

(57) ABSTRACT

The present technology is directed generally to media reconditioning and/or recovery systems for use in fluid filtration. In some embodiments, a reconditioning system includes an additive source configured to inject an additive into a fluid filtration chamber for media reconditioning. In several embodiments, a controller controls the timing, sequence, amount, and/or duration of additive injection. The additive can be selected to achieve a desired filtration outcome. In some embodiments, the system further includes a recovery component configured to redirect and capture the filtered media.

### TECHNICAL FIELD

The present technology relates generally to fluid treatment systems. In particular, several embodiments are directed toward integral media treatment systems, and associated devices and methods.

### BACKGROUND

Purified water is used in many applications, including the chemical, power, medical and pharmaceutical industries, as well as for human consumption. Typically, prior to use, water is treated to reduce the level of contaminants to acceptable limits. Treatment techniques include physical processes such as filtration, sedimentation, and distillation; biological processes such as slow sand filters or activated sludge; chemical processes such as flocculation and chlorination; and the use of electromagnetic radiation such as ultraviolet light. In water treatment applications, contaminants from wastewater such as storm water runoff, sediment, heavy metals, organic compounds, animal waste, and oil and grease must be sufficiently removed prior to reuse. Water purification plants and water purification systems often make use of numerous water filtration units for purification. It would be desirable to provide improved filtering units to reduce the expense and complexity of such purification systems.

### BRIEF DESCRIPTION OF THE DRAWINGS

FIG. 1 is a partially schematic illustration of a fluid treatment system having a media treatment system configured in accordance with embodiments of the present technology.

FIG. 2 is a schematic illustration of an automated media treatment system configured in accordance with embodiments of the technology.

FIG. 3 is a schematic illustration of a media treatment system configured in accordance with further embodiments of the technology.

FIG. 4 is a partially schematic illustration of a fluid treatment system configured in accordance with still further embodiments of the technology.

### DETAILED DESCRIPTION

The present technology is directed generally to media treatment systems for use in media-aided fluid filtration. In some embodiments, a media treatment system includes an additive source configured to inject an additive into a fluid filtration chamber for media reconditioning. In several embodiments, a controller controls the timing, concentration, and/or volume of an additive injection. An additive can be selected to achieve a desired media treatment or reconditioning outcome, such as to remove contaminants from the media and/or redirect and capture the one or more commodities separated from the media.

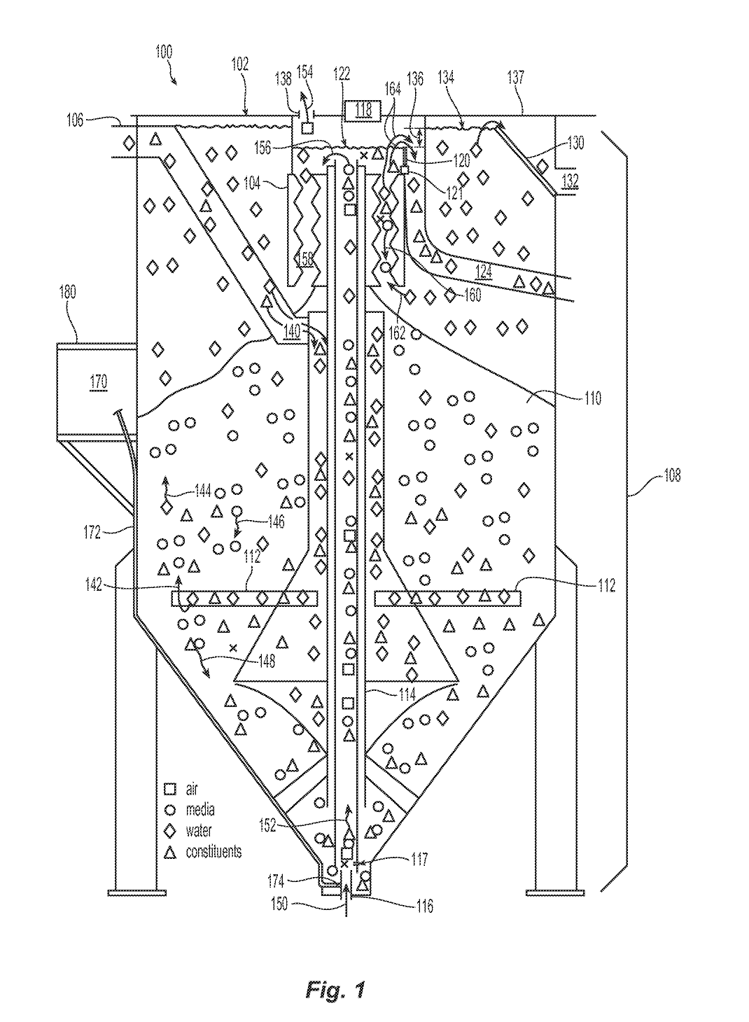

Specific details of several embodiments of the technology are described below with reference to FIGS. 1-4. Other details describing well-known structures and systems often associated with fluid filtration systems have not been set forth in the following disclosure to avoid unnecessarily obscuring the description of the various embodiments of the technology. The media treatment system described herein is not limited to use with a moving-bed media filtration system and may be used with other fluid treatment devices, including those that utilize fixed, flowing or fluidized media. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1-4.

FIG. 1 is a partially schematic illustration of a fluid treatment system 100 configured in accordance with embodiments of the present technology. The fluid treatment system 100 can receive water containing one or more constituents, and can separate the constituents from a majority of the water. The fluid treatment system 100 can produce a large percentage of relatively clean effluent water and a small percentage of water concentrated with the constituents in a waste and/or recovery stream, as described in greater detail below. As used herein, “constituents” refer to contaminants (e.g., scale, etc.) and/or commodities (e.g., dissolved solids, oils, paraffins, organics, metals, inorganic materials, etc.). For ease of reference, water containing such constituents is referred to herein as “contaminated water” even though the water may contain only commodities and no contaminants.

In the embodiment shown in FIG. 1, the system 100 includes a vessel 102 associated with a media treatment system 180. The vessel 102 receives water having one or more constituents for treatment through an inlet 106. As depicted in FIG. 1, water is represented by a diamond symbol “⋄” while constituents are represented by a triangle symbol “Δ”. The vessel 102 includes a filter chamber 108 that contains a media bed 110 with individual media (e.g., sand) represented by a circle symbol “O”. The inlet 106 extends down into the filter chamber 108 to discharge the contaminated water into a central portion of the media bed 110 through a distribution member or perforated manifold 112. In the embodiment shown in FIG. 1, the manifold 112 has a plurality of arms extending radially into the body of the media bed 110.

The system 100 can include an airlift or recirculation tube 114 that generally extends from the bottom to the top of filter chamber 108 at the center of vessel 102. An orifice 116 positioned below the recirculation tube 114 allows compressed air to be supplied to vessel 102. As depicted in FIG. 1, air is represented by a square symbol “□”. The orifice 116 can be positioned so that released compressed air tends to travel up into and through the recirculation tube 114 rather than outside of the recirculation tube 114 and into the media bed 110. In an alternative configuration, compressed air can be supplied via a conduit (not shown) that runs down through the vessel 102 and/or filtration chamber 108 generally coextensive to recirculation tube 114. The conduit provides the compressed air to an orifice(s) 117 that can release the compressed air into, or proximate to, the recirculation tube 114. In either scenario, the released air rises within the recirculation tube 114 to its upper end which is proximate to the adjustable washbox 104.

The system 100 can further include an adjustable washbox 104 can include a washbox configuration adjustment mechanism 118 for adjusting one or more parameters of the washbox as will be described below. The adjustable washbox 104 can include a water control mechanism in the form of a weir 120 and a weir control mechanism 121. The weir 120 physically blocks water above the adjustable washbox 104. The weir control mechanism 121 can adjust weir parameters, such as a height of weir 120 to control a water level 122 above the adjustable washbox 104. In other implementations, washbox configuration adjustment mechanism 118 can control the operation of weir 120 rather than having a dedicated weir control mechanism.

The adjustable washbox 104 functions to break-up any clumps of media that enter the washbox 104 and/or to further separate constituents from the media. An outlet 124 carries the separated constituents from the vessel 102 to be concentrated as a process reject, backwash, and/or a recycle stream. The system 100 also includes a water control mechanism in the form of a weir 130 for controlling outflow of filtered water via an outlet 132. Stated another way, weir 130 defines a water level 134 of the filter chamber 108 excluding the water level 122 controlled by weir 120. A head pressure or difference 136 between the washbox water level 122 and the filter chamber water level 134 causes water to flow upward from filter chamber 108 through the adjustable washbox 104. Further, in this instance, the vessel 102 includes an upper or top member 137 that seals the vessel 102 and a gas outlet 138 positioned in the top member 137. In other implementations, the vessel 102 does not include a top member and is directly open to the atmosphere. To summarize, the media bed 110 utilizes media to separate or filter constituents from the inflowing water. The adjustable washbox 104 then utilizes a relatively small percentage of the filtered water to separate the constituents from the media. The media is then recycled back to the media bed for further use.

The media treatment system 180 is configured to inject or more additives into the filtration chamber 108 and/or vessel 102 to enhance the separation of the constituents from the media. The media treatment system 180 can include an additive source 170 that stores or houses one or more additives such as solvents, dispersants, soaps, acids, bases, anti-scalants, and/or other additives suitable for separating the constituents from at least a portion of the media. The additive utilized can vary depending on the application and purpose of the fluid treatment process, type of media, and type of solids being removed or captured by the media. For example, the additive can be selected for a range of purposes including, but not limited to, recovery of oils, paraffins, organics, metals, and/or inorganic materials. In some embodiments the media treatment system 180 can include more than one additive source. Additionally, the additive source 170 can be positioned remote from, adjacent to or made integral with the vessel 102.

The additive source 170 can be coupled (e.g., via a conduit 172) to a valve 174 positioned at one or more locations at, on or within the filtration chamber 108 and/or vessel 102 (shown by an “X” in several representative locations). The valve 174 can be an orifice, a one-way valve, a sequencing valve, a manually controlled valve, an automatically controlled valve, an injector or other suitable valve. In several embodiments, the media treatment system 180 can also include a pressure difference device or pump (described below with reference to FIG. 3) configured to transfer additive from the additive source 170 to the valve 174. The pump can be the same pump utilized by the recirculation tube 114 or a separate pump.

Incorporation of the media treatment system 180 into the fluid treatment system 100 cleanses and reconditions the media by efficient removal of captured contaminants from fluid processing and/or recovery of captured commodities. The media treatment system 180 can be used for media washing to prevent fluid treatment system failure and/or as a commodity recovery system. More specifically, the system 180 can be integrated for anti-scaling and removal of precipitates from the media. This can be important to maintain the functionality of process equipment that relies on surface area and free reactive sites on the media for removal of constituents from the fluid being treated. Scaling and precipitate buildup on the media and/or equipment can increase pressure drop across the process equipment as well as fuse the media together within the media bed. For example, calcium scaling in water treatment applications can be avoided where a sand filter is the fluid treatment process for the removal of suspended and dissolved solids. The system 180 could be integrated to remove scaling continuously at a low operating setting, and/or it can be used more vigorously on a periodic schedule. In addition to contaminant capture, the media treatment system 180 can facilitate recovery of precipitated or captured solids removed from the media. For example, the solids can be a desirable commodity, as opposed to simply a contaminant or waste product. In some embodiments, the system 100 can separate the solids and dissolved constituents from the media and allow them to be concentrated in a process reject, backwash, or recycle stream through, for example, outlet 124.

In operation, contaminated water enters the vessel 102 via the inlet 106. The contaminated water then passes downward through the inlet as indicated by arrows 140 and into the manifold 112. The contaminated water exits the manifold 112 into the media bed 110 as indicated by arrow 142. As the contaminated water exits the manifold, a majority of the water flows upward (“an upflow system”) through the media bed as indicated by arrow 144 while media moves downward as indicated by arrow 146. It should be noted that the media treatment concepts described herein can be employed with a downflow system and/or other systems.

As mentioned above, each of the media has one or more free reactive sites whereby one or more of the constituents exiting the manifold 112 may become associated with or develop an affinity for the media. Constituents retained in the media bed by such an affinity are generally carried downward with the media as indicated by arrow 148. As a result, the media associated with one or more constituents (referred to herein as “associated media”) tend to sink below the manifold 112, while the unassociated media are generally located above the manifold. Accordingly, at least one media treatment system valve 174 can be positioned below the manifold 112 where there is an increased concentration of associated media so that an additive released from the valve 174 is exposed to a high concentration of associated media. For example, the valve 174 may be positioned within the media bed below the manifold 112 and/or or at any location within the vessel downstream of the manifold 112.

Compressed air supplied to the vessel 102 via the orifice 116 forms air bubbles that are less dense than the surrounding media and water. The air bubbles rise upwardly as indicated by arrow 150 and carry the media and/or constituents upwardly into and through at least a portion of the recirculation tube 114 as indicated by arrow 152. The media treatment system can have a valve 174 positioned at the base of the recirculation tube 114 that can leverage the pressure generated by the air bubbles to disperse the additive through the recirculation tube 114 and into the washbox 104. Likewise, a valve 174 can also be located at any location along the tube 114. A scouring action occurs as the air bubbles, media, and constituents travel through the recirculation tube 114. The scouring action tends to cause the constituents to be dislodged and/or separated from the media. Upon arrival at the top of the recirculation tube 114, the air bubbles tend to rise up and leave the vessel 102 through the gas outlet 138 as indicated by arrow 154. The media is relatively dense and tends to fall down around the mouth of the recirculation tube 114 and into the adjustable washbox 104 as indicated by arrow 156.

Constituents tend to be less dense than the media and as such tend to float on the water above the adjustable washbox 104. Some of the constituents may still be in some way attached to, or associated with, the media and as such tend to be carried downward with the media into the adjustable washbox 104. The adjustable washbox 104 can function to break up clumps of media and/or to separate constituents from the media. In some embodiments, a valve 174 can be located anywhere within the washbox 104 for addition of the additive to the washbox 104 to enhance the separation process. In the embodiment shown in FIG. 1, the adjustable washbox 104 defines a tortuous pathway as indicated by arrow 158. The relatively dense media falls downward along tortuous pathway 158 as indicated by arrow 160. Because of the head pressure 136, water tends to flow upwardly from the filter chamber 108 along the tortuous pathway 158 as indicated by arrow 162. Accordingly, the water creates a countercurrent flow to the descent of the media. Functionally, the countercurrent flow and/or interactions of the descending media with the washbox surfaces defining the tortuous pathway 158 can cause clumps of media to be broken up and constituents to be carried upwardly with the water. Water and/or constituents flow over weir 120 as indicated by arrows 164 to form a waste stream that is removed via the outlet 124.

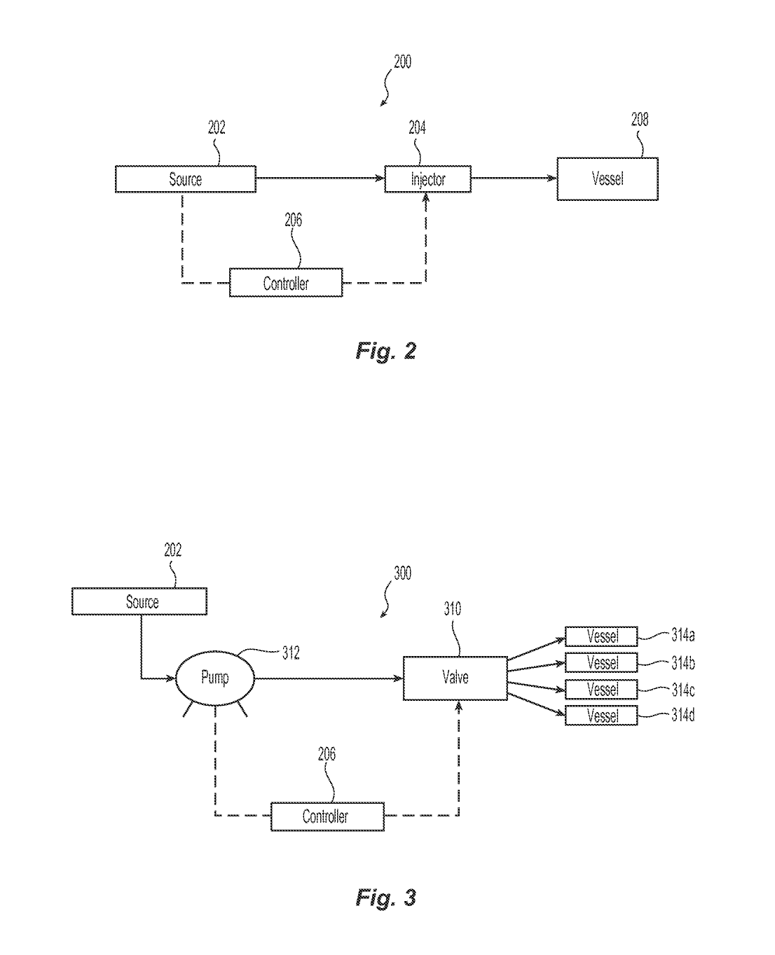

FIG. 2 is a schematic illustration of an automated media treatment system 200 configured in accordance with embodiments of the technology. The system 200 includes several features described above with reference to FIG. 1. The media treatment system 200 includes an additive source 202 which provides additives to the vessel 208 via a valve or injector 204. In several embodiments, a controller 206 is configured to control the activation and/or timing of the valve 204. The controller 206 can comprise a processor, programmable logic controller, rudimentary controller (on/off), sensor, display, input/output components, telemetry components, and/or other feature known in the computing arts. For example, the fluid treatment system may include one or more sensors located within the vessel to provide feedback to the controller 206 based on measurements such as the concentration of one or more of the constituents and/or the concentration of the additive(s) present in the vessel 208. The controller can include one or more algorithms configured to measure and/or calculate data based on the measurements to adjust the timing, volume, and/or concentration of the additive accordingly. In various embodiments, the injection of additive via the valve 204 can be continuous or periodic. In particular embodiments, the valve 204 can operate according to a user-created logic program stored on memory in the controller 206. In a particular embodiment, the controller 206 comprises a human machine interface integrated for regulation of system components (e.g. pump rate) and process monitoring.

FIG. 3 is a partially schematic illustration of a media treatment system 300 configured in accordance with another embodiment of the technology. The system 300 includes several features described above with reference to FIGS. 1 and 2. As shown in FIG. 3, the system 300 can be configured to service more than one vessel (e.g., 314a-314d, respectively) utilizing a single pump 312. The fluid treatment system 100 described herein provides advantages over traditional systems in that a single pump supports multiple isolated filtration chambers 108 and/or vessels 102 each potentially having different pressure properties. In the illustrated embodiment, the valve comprises a sequencing valve 310 configured to distribute the additive from the additive source 202 to the one or more vessels. A pump 312 can provide the pressure to feed the additive from the additive source 202 to the sequencing valve 310. The pump 312 can be the same pump or a different pump than that utilized for the recirculation tube 114.

The timing of the sequencing can be controlled by the controller 206. For example, additive may be added to a first vessel 314a at a first time and to a second vessel 314b at a second time different than a first time. Likewise, additive may be injected to the first valve 314a and the second valve 314b at the same time. The timing can comprise a pre-set program or can be controlled in real-time (e.g., via a user interface). The controller can provide reliable, precisely-tuned equal or different distributions of additive to the individual vessels 314a-314d. The sequencing valve 310 can add the same or different volumes and/or concentrations to all or some of the vessels.

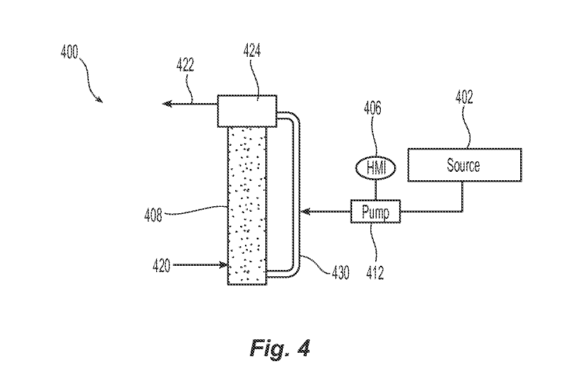

FIG. 4 is a partially schematic illustration of a fluid treatment system 400 configured in accordance with embodiments of the technology. The system 400 includes several features described above with reference to FIGS. 1 through 3. For example, the system 400 includes an additive source 402, a pump 412, a filtration chamber 408, and a recirculation tube 430. The illustrated filtration chamber 408 includes an inlet 420 and an outlet 422. A controller (e.g., a human-machine interface “HMI”) 406 can provide for control of injection from the additive source 402 into the filtration chamber 408. In some embodiments, the controller 406 can provide for continuous or intermittent injection from the additive source 402 in a continuously backwashing media filter system.

From the foregoing it will be appreciated that, although specific embodiments of the technology have been described herein for purposes of illustration, various modifications may be made without deviating from the spirit and scope of the technology. Further, certain aspects of the technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A system comprising:
a vessel configured to contain a media bed having one or more media therein;
an inlet configured to direct a fluid having one or more constituents into the vessel; and
a media treatment system coupled to the vessel, wherein the media treatment system includes—
an additive source;
a valve coupled to the additive source and configured to provide a quantity of one or more additives into the vessel to separate the constituents from the media; and
a controller in communication with the injector, the controller configured to control at least one of a timing, a volume and a concentration of an additive injection.

2. The system of claim 1 wherein the media treatment system further includes a pressure difference device coupled to the injector and configured to facilitate transfer of the one or more additives from the additive source to the vessel.

3. The system of claim 1 wherein:
the vessel is a first vessel and the system further includes a second vessel;
the injector comprises a valve having a first outlet connected to the first vessel and a second outlet connected to the second vessel; and
the media treatment system further includes a pressure difference device coupled to the injector and configured to facilitate transfer of the one or more additives from the additive source to the first vessel and from the additive source to the second vessel.

4. The system of claim 3, further including a controller coupled to the valve and configured to control at least one of a timing, a volume, a concentration and a sequencing of the additive injection.

5. The system of claim 1 wherein the vessel further includes one or more sensors configured to provide feedback to the controller based on at least one of an additive concentration or a free contaminant concentration within the vessel.

6. The system of claim 1 wherein:
the vessel further comprises a recirculation tube positioned within the vessel and generally coaxial to the vessel, wherein the recirculation tube is configured to direct at least one of the fluid, the constituents, and the media from a first end of the vessel toward a second end of the vessel; and
the injector has an outlet at the tube.

7. The system of claim 1 wherein the vessel further comprises:
a washbox configured to facilitate separation of at least two of the fluid, the media and the constituents; and
the injector has an outlet at the washbox.

8. The system of claim 1 wherein:
the media bed further includes a first portion having a first concentration of an associated media and a second portion having a second concentration of an associated media, wherein the first concentration is greater than the second concentration, and FIX
wherein the injector has an outlet at the first portion of the media bed.

9. The system of claim 1, further comprising a recovery component configured to redirect and capture filtered media.

10. A method, comprising:
inletting a fluid having one or more constituents to a vessel via an inlet, wherein the vessel contains one or more media;
exposing the fluid to the media;
binding the constituents to the media;
injecting a quantity of an additive into the vessel, wherein the additive is configured to disrupt an affinity between the media and the constituents; and
disrupting the affinity between the media and the constituents.

11. The method of claim 10, further comprising controlling at least one of the volume, concentration, and timing of the injecting via a controller.

12. The method of claim 10, further comprising recycling at least one contaminant after disrupting the bond between the media and the constituents.

13. The method of claim 10, further comprising reusing the media after disrupting the bond between the media and the constituents.

14. The method of claim 10 wherein injecting the quantity of the additive into the vessel comprises inletting the additive into a first vessel via an injector at a first time, and wherein the method further comprises inletting the additive to a second vessel via the injector at a second time different than the first time.

15. The method of claim 10 wherein injecting the quantity of the additive into the vessel comprises injecting a first additive concentration into a first vessel, and wherein the method further comprises injecting a second additive concentration to a second vessel, wherein the second additive concentration is different than the first additive concentration.

16. The method of claim 10 wherein injecting the quantity of the additive into the vessel comprises injecting the additive into a first vessel, and wherein the method further comprises injecting the additive into a second vessel simultaneously with injecting the additive into the first vessel.

17. The method of claim 10 wherein injecting the quantity of the additive into the vessel further comprises applying a pressure differential across an injector.

18. The method of claim 10 wherein injecting the quantity of the additive into the vessel further comprises injecting the additive into a washbox at least partially contained within the vessel.

19. The method of claim 10 wherein injecting the quantity of the additive further comprises injecting the additive into a recirculating tube at least partially contained within the vessel.

20. A media treatment system comprising:
an additive source;
an injector coupled to the additive source and configured to provide a quantity of one or more additives into the vessel to separate the constituents from the media; and
a controller in communication with the injector, the controller configured to control at least one of a timing, a volume and a concentration of an additive injection.
